(19) United States
(12) Patent Application Publication
(10) Pub. No.: US 2024/0272185 A1
(43) Pub. Date: Aug. 15, 2024

(54) GRIPPING DEVICE WITH PUSH-PUSH MECHANISM FOR AN ANALYSIS DEVICE

(71) Applicant: Agilent Technologies, Inc., Santa Clara, CA (US)

(72) Inventors: Blasius Nocon, Rheinstetten (DE); Christoph Geiger, Birkenfeld (DE)

(21) Appl. No.: 18/437,876

(22) Filed: Feb. 9, 2024

(30) Foreign Application Priority Data
Feb. 13, 2023 (DE) 10 2023 103 399.9

(51) Int. Cl. G01N 35/00; G01N 35/02

(52) U.S. Cl. CPC G01N 35/0099; G01N 35/026

(57) ABSTRACT

A sample handling device for handling a sample container, in particular for an analysis device for analyzing a fluidic sample in the sample container, includes: i) a push-push mechanism for fixing and releasing the sample container; and ii) a coupling region for releasably coupling to a sample moving device. The sample handling device is a passive device which is adapted to perform the fixing and the releasing free of a drive, in particular a motor. Furthermore, a related sample handling arrangement, an analysis device, and a method are described.

### CROSS-REFERENCE TO RELATED APPLICATIONS

This application claims priority under 35 U.S.C. § 119(a) to German Application No. DE 10 2023 103 399.9, filed on Feb. 13, 2023; the entire contents of which are incorporated by reference herein.

### TECHNICAL FIELD

The present invention relates to a sample handling device for handling a sample container in connection with an analysis device for analyzing a fluidic sample which is located in the sample container. Furthermore, the invention relates to a sample handling arrangement which comprises the sample handling device and a sample moving device. Moreover, the invention relates to an analysis device, a use, and a method for handling a sample container.

### BACKGROUND

Analysis devices, such as sample separation devices, are intended for the analysis of a sample, in particular a fluidic sample, e.g. for performing a chromatographic separation of the sample.

In a HPLC (high-performance liquid chromatography) analysis device, for example a liquid (mobile phase) at a highly controlled flow rate (for example in a range from microliters to milliliters per minute) and at a high pressure (typically 20 to 1000 bar and more, currently up to 2000 bar), where the compressibility of the liquid may be noticeable, is moved through a so-called stationary phase (for example in a chromatographic column), to separate single fractions of a sample liquid which is introduced in the mobile phase from each other. After passing the stationary phase, the separated fractions of the fluidic sample are detected in a detector. Such a HPLC-system is for example known from EP 0,309,596 B1 of the same applicant, Agilent Technologies, Inc.

Fluidic samples (liquids or gases) are typically stored in sample containers, mostly in so-called vials, until they are supplied to the analysis in an analysis device. For example, the fluidic sample may be removed from the sample container by a sample needle and may then be introduced in a fluidic path of the analysis device. Such a sample removal is typically performed in a sampling space (so-called sampler) which is specifically provided for this purpose. Since a multiplicity of sample containers may be located in the sampling space, one or more robot arms are used, to i) on the one hand remove the fluidic sample from the sample containers and supply it to the analysis region, and to ii) on the other hand transport the sample containers. In the latter case, conventionally so-called vial-grippers are used. These use electromechanic, electropneumatic, or electromagnetic mechanisms to actively grip a sample container.

FIG. 2 shows a sampling space 180 with a conventional active gripper device 200. In the sampling space 180, multiple sample container receiving devices 137 (so-called pallets or well-plates) are arranged, each of which being capable of receiving a plurality of sample containers 130. The sampling space 180 is separated by a housing (which has a door) and constitutes an autonomous region of the analysis device 10 with its own ambient conditions, in particular tempering. For transporting sample containers (e.g. from a sample container receiving device 137 to a further sample container receiving device), a robot arm is provided which is equipped with a gripper head 205. Mechanically gripping the sample container 130 is performed by three pins which, similar to a human hand, perform an active gripping motion as gripping fingers. FIG. 3 shows the conventional active gripper head 200 of FIG. 2 with the gripping pins in detail. Moving the robot arm and opening/closing the gripping pins is performed by a motor 220 which is directly connected with the gripping pins of the gripper head 205 via cables.

Finally, all the known gripper devices require an active drive (e.g. a motor) and an associated control for the gripping process, which may finally have a pronounced influence on the robustness and the costs. At the same time, such a gripping device, besides an additional robot arm which is adapted for removing the fluidic samples by a sample needle, has to be arranged within the small sampling space.

### SUMMARY

There may be a need to transport a sample container (in particular with a fluidic sample for an analysis device) in an efficient and flexible manner (within a sampling space).

According to an exemplary embodiment of the present disclosure, a sample handling device (or sample container handling device, gripper device) for handling a sample container ((in particular vials) for storing a fluidic sample) is described, in particular for an analysis device (e.g. a HPLC) for analyzing the fluidic sample (of the sample container), wherein the sample handling device comprises:
i) a push-push mechanism (or click-action pen mechanics) for fixing (receiving) and/or releasing (discharging) the sample container (from the sample handling device), and
ii) a coupling region for (reversibly or irreversibly) coupling (the sample handling device), e.g. to a sample moving device (e.g. a movable robot arm).

Here, the sample handling device is a passive device which is adapted to perform the fixing and/or the releasing by the push-push mechanism free of a drive, in particular a motor (and a drive coupling) (in particular, the sample handling device is free of such a drive and/or of such a drive coupling).

According to another exemplary embodiment of the present disclosure, a sample handling arrangement is described, comprising:
i) a sample handling device as described above, and
ii) the sample moving device which comprises: a further coupling region for (releasably or non-releasably) coupling the sample handling device.

Here, the sample handling device and the sample moving device are (e.g. magnetically, by screwing-in, etc.) coupled/couplable with each other by the coupling and the further coupling.

According to a further exemplary embodiment of the present disclosure, an analysis device for analyzing a fluidic sample (which is to be injected into a mobile phase, for example) is provided, wherein the analysis device comprises at least one sample handling device and/or sample handling arrangement with the above-described features for handling the sample containers for the fluidic sample.

According to another exemplary embodiment of the present disclosure, a use of a push-push mechanism for fixing and/or releasing a sample container with respect to a passive (i.e. free of a drive, in particular a drive coupling) gripper device of an analysis device is described.

According to a further exemplary embodiment of the present disclosure, a method for handling a sample container, in particular for an analysis device for analyzing a fluidic sample in the sample container, is described, the method comprising:
i) coupling a sample handling device to a sample moving device,
ii) pressurizing the sample handling device (in particular in the direction of the sample container) by the sample moving device, and thereby
triggering a push-push mechanism of the sample handling device for fixing and/or releasing the sample container (from the sample handling device).

In the context of the present application, the term “sample handling device” or “sample container handling device” may in particular denote a device which is suitable for handling a sample container which is adapted for storing a fluidic sample. Such a sample handling device may be configured as a gripper device (-head) and may fix and/or release the sample container. In an embodiment, the fixing/releasing is respectively triggered by a push-push mechanism. The sample handling device may comprise a housing, wherein the push-push mechanism is at least partially arranged within the housing. In addition, the sample handling device may be coupled to a further device, in particular a sample moving device, whereby moving the sample handling device may be enabled. This may be of importance, in particular since the sample handling device may be a passive device which does not comprise an own drive and/or an own drive coupling.

In the context of the present application, the term “coupling region” may in particular denote a region of a sample handling device which is adapted to enable a coupling with a further coupling region, in particular of a sample moving device. In an example, further devices may be connected between the sample handling device and the sample moving device. In an exemplary embodiment, the sample moving device comprises a needle arrangement and the further coupling region is realized as a surface which otherwise is placed on a sample container and through which the sample needle is extendable. Apart from that, the coupling may be realized in many different manners, e.g. by fixedly clamping, screwing-in, a bayonet lock, magnetically, hydraulically, electrically pneumatically, etc. In an embodiment, the coupling may be reversible or releasable, whereby a high flexibility in operation may be enabled. In another embodiment, the coupling may be permanent or non-releasable, whereby the stability may be increased.

In the context of the present application, the term “push-push mechanism” may in particular denote a mechanics in which it is enabled to switch between at least two states or positions by a pressure impact; namely such that the same pressure impact alternately enables the first state and the second state. This mechanism as such is known and is realized e.g. in a click-action pen. However, in the field of analysis devices, in particular with regard to transporting sample containers, the use of this mechanics is unknown. A multiplicity of possibilities for realizing a push-push mechanism exist. However, it may preferably comprise a pushing element and a spring element. The pushing element may serve for a force transmission, when the pressure impact occurs, e.g. the pushing element may be directly pushed on the (lid of the) sample container. The spring element may be coupled with the pushing element and may comprise a different (pre-) tension in both states. In an exemplary embodiment, the spring element is configured as an elastic spring which, by a so-called heart curve mechanics, can change between a tensioned state and a non-tensioned state, respectively triggered by the pressure impact.

In the context of the present application, the term “passive device” may in particular denote a device which is adapted to perform a fixing/releasing of a sample container without an active drive and/or a (direct) coupling to an active drive. In particular, the device does not comprise such a drive and/or such a drive coupling or is free of it. The term “drive” may here denote a device which is suitable to provide a physical, in particular mechanical, force. The drive may be an electric motor. Conventionally (see FIGS. 2 and 3), a gripper device is directly connected to the motor of a robot arm (drive coupling), such that the gripper head can be actively moved by the motor. However, in an example, exactly this is made impossible in a passive device, i.e. the sample handling device may thus be moved by a sample moving device, but may not autonomously realize an active motion. It is to be noted that the push-push mechanism cannot be triggered by the sample handling device itself, but by a pressure impact from exterior (e.g. by the sample moving device or also manually by a user). In other words, the sample handling device does not require an active drive device to enable the fixing and/or releasing of the sample container.

In the context of the present application, the term “fluid” in particular denotes a liquid and/or a gas, optionally comprising solid body particles.

In the context of the present application, the term “fluidic sample” in particular denotes a medium, further in particular a liquid, which contains the substance which is actually to be analyzed (for example a biological sample), such as a protein solution, a pharmaceutical sample, etc.

In the context of the present application, the term “mobile phase” in particular denotes a fluid, further in particular a liquid, which serves as a carrier medium for transporting the fluidic sample between a fluid drive and a sample separation unit. However, the mobile phase may also be used in a fluid conveying unit for influencing the fluidic sample. For example, the mobile phase may be a (for example organic and/or inorganic) solvent or a solvent composition (for example water and ethanol).

In the context of the present application, the term “analysis device” may in particular denote a device which is capable and configured to examine, in particular to separate, further in particular to separate into different fractions, a fluidic sample. For example, such a sample Septemberaration may be performed by chromatography or electrophoresis. The analysis device may be a liquid chromatography sample separation device.

In the context of the present application, the term “sample needle” may in particular denote a hollow body with a lumen or a through hole, through which a fluidic sample can be guided. Through the lumen or through hole, in particular a fluidic sample may be introduced into (for example sucked into) a sample handling device, and/or may be guided out of (for example ejected out of) a sample handling device. A sample needle may be elongated and rotationally symmetrical and may thus comprise a symmetry axis.

In the context of the present application, the term “lumen for guiding a fluidic sample” may in particular denote a through hole which extends through the sample needle, through which a fluid, and in particular a fluidic sample, may flow.

In the context of the present application, the term “sample moving device” may in particular denote a component or an assembly which can perform at least one motion (in particular a rotational motion), for example in order to mechanically displace another component (for example a sample needle and/or a coupled sample handling device) which is arranged at a motion apparatus according to the cantilever-type. Alternatively or additionally, the sample moving device may be configured for performing at least one translatory and/or rotational motion, for example for vertically lifting or lowering a component (for example a sample needle and/or the sample handling device).

According to an exemplary embodiment, the present disclosure may be based on the idea that a sample container (in particular with a fluidic sample for an analysis device) can be transported (within a sampling space) in an efficient and flexible manner, when a passive, i.e. drive-free, sample handling device or gripper device is provided, which is couplable with an active, i.e. driven, sample moving device, and which comprises a push-push mechanism for fixing/releasing the sample container.

Thus, the present disclosure may describe a passive, couplable gripper device as a separate component which, without active components (e.g. motors), can receive and release again sample containers in an analytical system. For this purpose, the sample handling device may be fixedly mounted at a robot and/or a sample moving device, but may also be decouplable and may only be received when required. For this purpose, the coupling region is used as a (mechanical) interface which may be releasable and thereby flexibly usable. The sample handling device may receive a sample container and may also release it again. In order to passively accomplish this, a push-push mechanism is used which is e.g. retracted when receiving the sample container and is e.g. extended when releasing the sample container, whereby ejecting is enabled. In an example, it is not necessary to provide current, air, or other operation substances, to operate the sample handling device. Furthermore, also a control specially for the sample handling device is not necessary.

This implementation contrasts with prior art (see FIGS. 2 and 3), whereas a gripper device always requires an active drive (and/or a direct coupling to a motor), to grip and/or to release a sample container. Conventionally, the gripper head and the robot arm must be fixedly connected, to realize corresponding drive-ports. Therefore, the present subject matter may enable to provide a higher efficiency and/or flexibility with distinctly less materials.

In the following, additional embodiments of the needle arrangement, the sample handling device, the analysis device, and the method are described.

According to an embodiment, the sample handling device further comprises: a housing in which the push-push mechanism is at least partially arranged. This may have the advantage that the sample handling device is configured in a stable and robust manner, and the mechanism is secured against pollution. For example, the housing may consist of plastic, metal, or ceramics. In an example, the housing is made of one piece, however, in other examples, the housing may be configured of two or more parts.

According to an embodiment, the push-push mechanism comprises: a pushing element which, in a first position, makes the fixing of the sample container impossible, and which, in a second position, enables the fixing of the sample container. Thereby, the push-push mechanism may be implemented in a simple and nevertheless efficient manner. The pushing element may be partially movably mounted (in particular coupled with a spring element), and may serve for the pressure transmission, when the pressure is exerted on the sample handling device. Thus, the pushing element may change from the first to the second position (and vice versa) by the pressure impact, such that fixing and releasing the sample container becomes specifically controllable.

According to an embodiment, a change from the first position to the second position and vice versa is respectively enabled by a pressure impact on the sample handling device. As already described above, the push-push mechanism may thereby be implemented in a simple and nevertheless efficient manner. In particular, the pressure impact may be implemented by the sample handling device being pushed “from above” (in a vertical direction or along the direction of the gravity) on the sample container. Then, by the counter pressure of the sample container, the pushing element may be moved and/or change the position.

According to an embodiment, the pushing element is at least partially arranged in the housing, and the pushing element, in the second position, is arranged further inside the housing than in the first position. This may have the advantage that the motion of the pushing element is performable in a space-saving and secure manner. As described in detail below, such a retraction of the pushing element may enable that a fixing element grips the sample container.

According to an embodiment, the pushing element is elongated. Thereby, the pushing element can at least partially be pushed into the housing in the longitudinal direction and/or vertically), in particular in the direction of the pressure impact. In particular, the term “elongated” may mean here, that the pushing element comprises a main extension direction in a spatial direction which is distinctly larger than (at least double) the extension in the both further spatial directions.

According to an embodiment, the pushing element is arranged such that a first pressure impact pushes the pushing element at least partially out of the housing, and a second pressure impact pushes the pushing element at least partially back into the housing. Descriptively, this is comparable with the press button of a click-action pen which, at a first pushing, is pushed and fixed in the housing, while, at a second pushing, the press button is pushed out of the housing in the initial position.

According to an embodiment, the pushing element is arranged such that the pushing direction is along the main extension direction (z) of the pushing element. Thereby, the push-push mechanism may be realized in an especially simple manner.

According to an embodiment, the pushing element is arranged such that the pressure impact is performed in the vertical direction or (substantially) in parallel to the gravity direction. Thus, in this example, the sample handling device can be directly pushed from above on the sample container, to enable a fixing/releasing.

According to an embodiment, the pushing element comprises at least one of the following materials: plastic, metal, ceramics. Depending on the application, a certain material may be especially advantageous.

According to an embodiment, the sample handling device further comprises: at least one fixing element which is adapted to releasably fix the sample container, in particular at a sample container lid. In an example, one or more fixing elements are provided which are not directly connected with the push-push mechanism but perform a fixing/releasing when the push-push mechanics enables it.

According to an embodiment, the push-push mechanism is adapted such that a fixing of the sample container by the fixing element is made impossible in the first position and is enabled in the second position. An exemplary descriptive example for this is illustrated in the FIGS. 5 and 6, wherein the pushing element is arranged between the fixing element, such that it provides a space for a fixing or blocks this space.

According to an embodiment, the fixing element comprises at least one of the following: a folding element, a latching element, a clamp, a hose, a web, a magnet. The fixing element may be implemented in a simple manner depending on the application. In a simple example (see FIGS. 5 and 6), the fixing elements are realized by latching elements (sheet metal clamps). However, also completely other configurations are possible, e.g. a (elastomeric) hose may be arranged around the pushing element. Also a magnet (in case of a magnetic sample container (lid)) or a (hose-like) web could be realized. Here, the skilled person may provide a multiplicity of implementations.

According to an embodiment, the fixing element comprises at least one of the following materials: metal, plastic, ceramics. In an example, the fixing element is at least partially flexible. Depending on the application, a certain material may be especially advantageous.

According to an embodiment, the push-push mechanism comprises a spring element, wherein the (pre-) tension of the spring element during fixing the sample container is higher than during releasing the sample container. In the context of this document, the term “springing” may denote that a change between two states/positions encompasses an extension and a retraction. This may be tensioning and releasing an elastic spring. However, also extending and contracting an air cushion may be considered as springing in this context.

According to an embodiment, the spring element is configured as (elastic) spring which, by a heart curve mechanics, is changeable between a fixed and a non-fixed position. A heart curve mechanics as such is known and enables the change between two positions by the same force impact. Thereby, an efficient and nevertheless simple implementation may be performed.

According to an embodiment, the fixed position is associated with the second position of the pushing element, and the non-fixed position is associated with the first position of the pushing element. Descriptively speaking, in an example, the pushing element, in case of a tensioned spring, may clear the space between the fixing elements and, in case of a not (or less) tensioned spring, may block the space.

According to an embodiment, the spring element comprises at least one of the following: an air cushion, an elastomer, an oil container, a gas pressure spring. All these examples may enable the above defined springing. Here, the skilled person may provide a multiplicity of implementations which may be preferred depending on the application.

According to an embodiment, the sample moving device is an active device which comprises a drive, in particular a motor. This may have the advantage that an active motion of the passive sample handling device is enabled without the need that it has to be an active device. In an example, the active motion can also trigger the push-push mechanism by the sample moving device. Thereby, the sample moving device and the sample handling device may flexibly cooperate depending on the need.

According to an embodiment, the sample moving device is adapted to exert a pressure on the sample handling device, such that the push-push mechanism is thereby activated.

According to an embodiment, the sample moving device comprises a robot arm or a cantilever arm. Such an arm is known as such and, depending on the need, enables efficiently and reliably moving/transporting within a sampling space.

According to an embodiment, the sample moving device comprises a needle arrangement, wherein the needle arrangement comprises a sample needle with a lumen for guiding the fluidic sample, in particular wherein the sample needle is movable through the further coupling. This may have the advantage that the sample handling device can be directly coupled to a present (and required) active device. Especially desirable, no or only less adaptions at the sample moving device are necessary to enable the coupling. In an embodiment, instead of at least two robots (one for transporting the sample and one for transporting the sample containers), only one is required, since transporting the sample containers may be executed by the flexibly couplable sample handling device, if required.

According to an embodiment of the method, the pressure acts through the sample moving device in the direction of the sample container (which provides a counter pressure with respect to the sample handling device). Thereby, in an especially simple and efficient manner, fixing/releasing can be implemented by a passive device. Descriptively speaking, the sample handling device is simply pushed on the sample container, in order to fix or to release it.

According to an embodiment, the analysis device is configured as a sample separation device. According to an embodiment, the analysis device comprises a fluid drive for driving a mobile phase and a fluidic sample which is injected in the mobile phase. According to an embodiment, the analysis device comprises a sample separation unit for separating the fluidic sample which is injected in the mobile phase. According to an embodiment, the analysis device is configured for analyzing at least one physical, chemical, and/or biological parameter of the fluidic sample. According to an embodiment, the analysis device is configured as a sample separation device for separating the fluidic sample.

In the context of the present application, the term “sample separation unit” may in particular denote a unit for analyzing a fluidic sample, in particular in different fractions. For this purpose, constituents of the fluidic sample may at first be adsorbed at the sample separation unit and may then be separately desorbed (in particular in fractions). For example, such a sample separation unit may be configured as a chromatographic separation column.

According to an embodiment, the analysis device is a chromatography device, in particular a liquid chromatography device, a gas chromatography device, a SFC-(supercritical liquid chromatography) device or a HPLC-(high-performance liquid chromatography) device.

According to an embodiment, the analysis device is configured as a microfluidic device. According to an embodiment, the analysis device is configured as a nanofluidic device.

According to an embodiment, the sample separation unit is configured as a chromatographic separation unit, in particular as a chromatography separation column.

According to an embodiment, the fluid drive is configured for driving the mobile phase and the fluidic sample under high pressure.

According to an embodiment, the fluid drive is configured for driving the mobile phase and the fluidic sample with a pressure of at least 500 bar, in particular of at least 1000 bar, further in particular of at least 1200 bar.

According to an embodiment, the analysis device comprises a detector for detecting the analyzed, in particular separated, fluidic sample.

According to an embodiment, the analysis device comprises a fractionator for fractionizing the separated fractions of the fluidic sample.

The analysis device may be a microfluidic measuring device, a life science device, a liquid chromatography device, a gas chromatography device, a HPLC (high-performance liquid chromatography) device, a UHPLC (ultra-high-performance liquid chromatography) device, or a SFC-(supercritical liquid chromatography) device. However, many other applications are possible.

According to an embodiment, the sample separation unit may be configured as a chromatographic separation unit, in particular as a chromatography separation column. In a chromatographical separation, the chromatography separation column may be provided with an adsorption medium. At this, the fluidic sample may be retained and may subsequently only be released in fractions in the presence of a specific solvent composition, whereby the separation of the sample in its fractions is accomplished.

For example, a pumping system for delivering the fluid may be adapted to deliver the fluid or the mobile phase with a high pressure, for example some 100 bar up to 1000 bar and more, through the system.

The analysis device may comprise a sample injector for introducing the sample into the fluidic separation path. Such a sample injector may comprise a sample-or injection needle which is couplable with a needle seat in a corresponding liquid path, wherein the sample needle can be extended out of this needle seat, to receive the sample. After reintroducing the sample needle in the needle seat, the sample may be located in a fluid path which, for example by switching a valve, can be connected with the separation path of the system. In another embodiment of the present disclosure, a sample injector and/or sampler with a sample needle may be used which is operated without a needle seat.

According to an embodiment, the needle arrangement may comprise a sample receiving volume which is fluidically coupled with the sample needle, in particular a sample loop. In particular, this may denote a piece of a capillary in whose interior a receiving volume for receiving a defined amount of the fluidic sample is formed.

The analysis device may comprise a fraction collector for collecting the separated components. Such a fraction collector may guide the different components of the separated sample, for example in different liquid containers. However, the analyzed sample may also be delivered to a drain container.

The analysis device may comprise a detector for a detection of the separated components. Such a detector may generate a signal which can be observed and/or recorded, and which is indicative for the presence and the amount of the sample components in the fluid which is flowing through the system.

According to an exemplary embodiment (see FIGS. 9 and 10), a sampling space is delimited by a housing in which the sample handling arrangement and/or sample moving device is/are arranged. The housing comprises an opening mechanism (e.g. a (sliding) door), wherein the sample moving device/-arrangement is adapted for opening and/or closing the opening mechanism, to thereby transport a sample container or a sample container receiving device into the housing and/or out of the housing.

According to an exemplary embodiment, a use of a sample handling arrangement and/or a sample moving device within a sampling space of an analysis device for opening and/or closing an opening mechanism of the sampling space is described, in particular to transport a sample container or a sample container receiving device into the sampling space and/or out of the sampling space.

According to an exemplary embodiment, a (typically already available) sampling robot (which is e.g. used for handling bottles in a HPLC sample injector) for moving a sample palette (typically consisting of multiple samples which contain vials) into and out of a housing of the HPLC sample injector, which may encompass opening/closing a door of the sample injector housing and moving the sample palette through this door. Such an “already available” sampling robot is typically a XYZ-robot (the three linear motions) with multiple rotatable axes. The sampling palette (which is moved by the sampling robot) does not necessarily require a certain access point (e.g. for gripping the sampling palette), however, such a dedicated access point may indeed be practical. This may have the advantage to use the same robot arm which is used for the manipulation of the samples in the sampler also for opening the door and for loading a new sample palette into the sampling space.

### BRIEF DESCRIPTION OF THE DRAWINGS

Other objects and many of the accompanying advantages of embodiments of the present disclosure are easy to recognize and better to understand with reference to the following detailed description of embodiments in connection with the accompanied drawings. Features which are substantially or functionally the same or similar are provided with the same reference signs.

FIG. 1 shows an analysis device according to an exemplary embodiment of the present disclosure.

FIG. 2 shows a conventional sampling space with an active gripper device.

FIG. 3 shows the conventional active gripper device in detail.

FIG. 4 shows a sample handling device according to an exemplary embodiment of the present disclosure.

FIGS. 5a to 5d show the fixing of a sample container to a sample handling device according to an exemplary embodiment of the present disclosure.

FIGS. 6a to 6d show the release of a sample container from a sample handling device according to an exemplary embodiment of the present disclosure.

FIG. 7 shows a sampling space with a sample handling arrangement according to an exemplary embodiment of the present disclosure.

FIG. 8 shows a sampling space with a sample handling arrangement according to an exemplary embodiment of the present disclosure.

FIGS. 9a to 9c show the transport of a sample container receiving device in a sampling space by a sample moving device according to an exemplary embodiment of the present disclosure.

FIGS. 10a and 10b show further views of the transport of a sample container receiving device in a sampling space by a sample moving device according to an exemplary embodiment of the present disclosure.

FIG. 11 shows a sampling space with a sample moving device according to an exemplary embodiment of the present disclosure.

The illustrations in the drawings are schematic.

### DETAILED DESCRIPTION

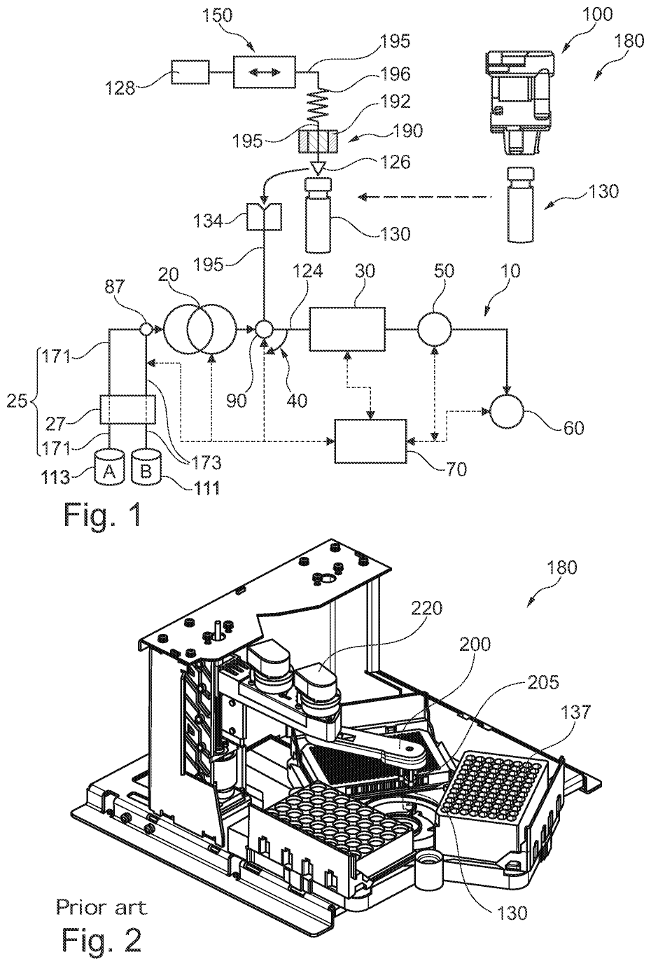

FIG. 1 shows the basic structure of a HPLC-system as an example for an analysis device 10 which is configured as a sample separation device, according to an exemplary embodiment of the present disclosure, as it may be used for a liquid chromatography, for example. A fluid conveying unit or a fluid drive 20, which is supplied with solvents from a supply unit 25, drives a mobile phase through a sample separation unit 30 (such as a chromatographic column), which contains a stationary phase. The supply unit 25 encompasses a first fluid component source 113 for providing a first fluid and/or the first solvent component A (for example water) and a second fluid component source 111 for providing another second fluid and/or a second solvent component B (for example an organic solvent). An optional degasser 27 may degas the solvents which are provided by the first fluid component source 113 and by the second fluid component source 111, before these are supplied to the fluid drive 20. A sample insertion unit which may also be denoted as injector 40, is arranged between the fluid drive 20 and the sample separation unit 30, to firstly receive a sample liquid and/or a fluidic sample out of a sample container 130 into a sample receiving volume 196 in a (only schematically illustrated) injector path 195, and to introduce it subsequently, by switching an injection valve 90 of the injector 40, into a fluidic separation path 124 between the fluid drive 20 and the sample separation unit 30. Receiving the fluidic sample out of the sample container 130 may in particular be performed by extending a sample needle 126 out of a sample seat 134 and displacing it into the sample container 130, by sucking the fluidic sample out of the sample container 130 through the sample needle 126 into the sample receiving volume 196 by a fluid conveying unit which is configured as a dosing or metering unit, and by retracting the sample needle 126 into the needle seat 134 again.

The stationary phase of the sample separation unit 30 is provided for separating the components of the sample. A detector 50 which may comprise a flow cell detects the separated components of the sample. A fractionizing device or fractionator 60 may be provided for discharging the separated components of the sample in containers which are provided for this purpose. Liquids which are not required anymore may be discharged in a drain container and/or a waste conduit.

While a liquid path between the fluid drive 20 and the sample separation unit 30 is typically under high pressure, the sample liquid under normal pressure is at first introduced into a region which is separated from the liquid path, namely the sample loop or the sample receiving volume 196 of the sample insertion unit and/or of the injector 40. Subsequently, the sample liquid is introduced into the separation path 124 which is under high pressure. A sample loop as sample receiving volume 196 may denote a portion of a fluid conduit which is configured for receiving and/or intermediate storing a pregiven amount of the fluidic sample. Before switching the sample liquid in the sample receiving volume 196 which is at first under normal pressure into the separation path 124 which is under high pressure, the content of the sample receiving volume 132 may be brought to the system pressure of the analysis device 10 which is configured as a HPLC by a dosing unit in form of the fluid conveying unit. A control unit 70 controls the single components 20, 25, 30, 40, 50, 60, 90, etc. of the analysis device 10.

FIG. 1 shows two supply conduits 171, 173, each of which being fluidically coupled with a respective of the two solvent containers which are denoted as fluid component sources 113, 111 for providing a respective one of the fluids and/or solvent components A and B. The respective fluid and/or the respective solvent component A and/or B is conveyed through the respective supply conduit 171 and/or 173, through the degasser 27 to a proportioning valve 87 as proportioning unit, at which the fluids and/or the solvent components A and/or B from the supply conduits 171, 173 are combined with each other. Thus, at the proportioning valve 87, the fluid packages from the supply conduits 171, 173 flow together under formation of a homogenous solvent composition. The latter is then supplied to the fluid drive 20.

In the operation of the analysis device 10, and in particular of the injector 40, the injection valve 90 is switched by the control unit 70 for injecting a fluidic sample from the sample receiving volume 196 into a mobile phase in the separation path 124 between the fluid drive 20 and the sample separation unit 30 of the analysis device 10. This switching of the injection valve 90 is performed for causing a relative motion between a first valve body (which may be a stator which is in rest with respect to a laboratory system) and a second valve body (which may be a rotor which is rotatable with respect to the laboratory system) of the injection valve 90. The first valve body may be provided with multiple ports and optionally with one or more groove-shaped connection structures. In contrast, the second valve body may be equipped with multiple groove-shaped connection structures, to thereby selectively fluidically couple or decouple respective ones of the ports of the first valve body depending on a respective relative orientation between the first valve body and the second valve body by the at least one connection structure of the second valve body. Descriptively, a respective groove-shaped connection structure of the second valve body, in certain switching states of the injection valve 90, may fluidically connect two (or more) of the ports of the first valve body with each other, and may form a fluidic decoupling between other ones of the ports of the first valve body. In this way, the single components of the sample separation device 90, depending on a respective operational state of the injector 40, may be brought together in an adjustable fluidic (de-) coupling state.

The sample containers 130 are stored in a sampling space 180 which is not shown in FIG. 1 (see FIGS. 2, 7, 8) in sample receiving devices 137. In the sampling space 180, a sample moving device 150 is provided which is movable within the sampling space 180 as an active device by a drive which is implemented as an electric motor. In this way, transporting the fluidic sample and/or the sample containers 130 is enabled.

In a first configuration, the sample moving device 150 comprises a needle arrangement 190 in which the sample needle 126 which is already mentioned above is (fixedly or rotatably) stored (reference sign 192). The sample needle 126 is connected with a sample receiving volume 196, whereby a part of the fluid path 195 is provided. By the sample needle 126, as described above, the fluidic sample may be drawn out of the sample container 130 into the sample receiving volume 196, and after the transport through the sampling space 180 in the needle seat 134, may be inserted into the further fluid path 195 of the analysis device 10.

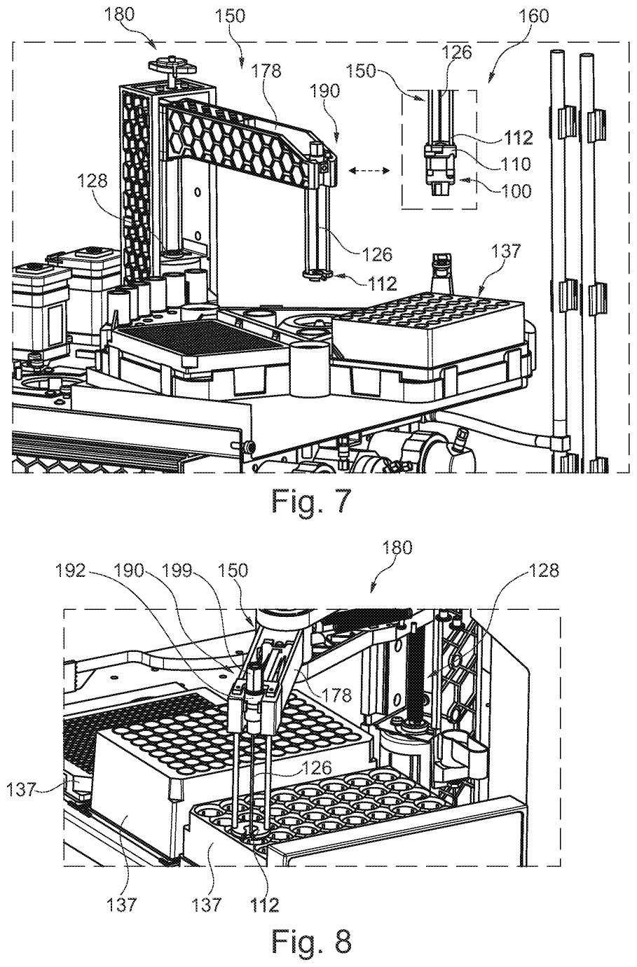

In a second configuration, the sample moving device 150 is coupled with a sample handling device 100, whereby a sample handling arrangement 160 is obtained (see in detail in FIG. 7). In this example, the sample handling device 100 may be directly coupled to the needle arrangement 190, or may, instead of it, be releasably connected to the sample moving device 150. The sample handling device 100 is described in detail with respect to the following figures and enables the transport of the sample containers 130, in particular within the sampling space 180. The sample handling device 100 and the needle arrangement 190 may therefore supplement each other and may cooperate in interaction with each other in the operation of the analysis device 10.

While the sample moving device 150 is an active device which is controlled and actively moved by a drive 128, the sample handling device 100 is a passive device which does not comprise a drive and is only movable in space by the sample moving device 150.

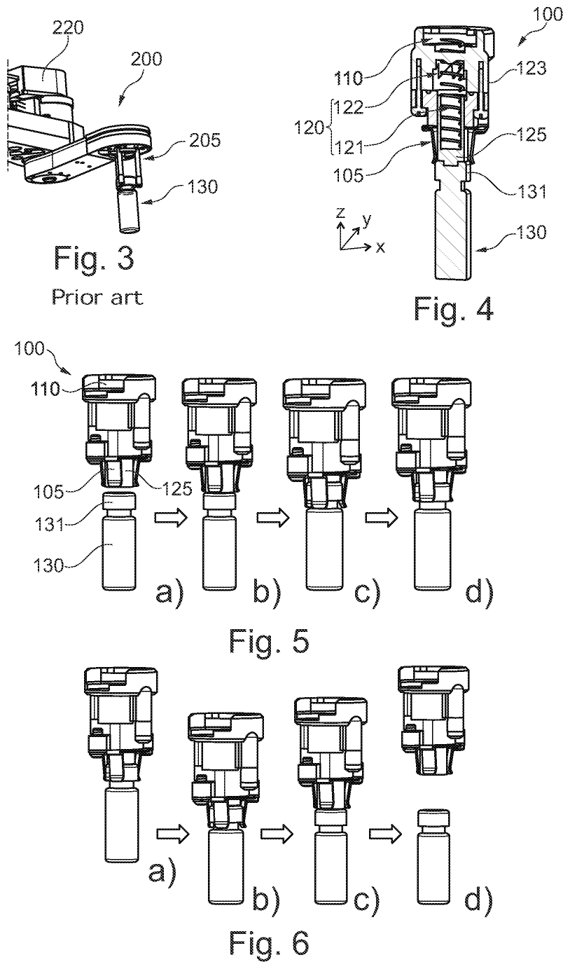

FIG. 4 shows a sample handling device 100 according to an exemplary embodiment of the present disclosure. The sample handling device 100 is adapted for handling a sample container 130 for the analysis device 10 for analyzing a fluidic sample in the sample container 130. The sample handling device 100 comprises a push-push mechanism 120 for fixing and releasing the sample container 130. Moreover, the sample handling device 100 has a coupling region 110 for releasably coupling to a sample moving device 150 (see e.g. FIG. 7). As described above, the sample handling device 100 is a passive device which is free of a drive, in particular a motor 128, and a direct coupling to such a one.

The sample handling device 100 comprises a housing 123 which is made of two pieces in this example (see indicated screwing). At the upper end of the housing 123, a coupling region 110 is provided. The coupling region 110 is configured such that it may be releasably (i.e. reversibly) coupled with a further coupling region 112 of a sample moving device 150. A multiplicity of couplings are possible here, for example a magnetic coupling, a bayonet lock, fixedly clamping, etc.

At the upper end of the housing 123, fixing elements 105 are in turn attached which extend from the housing 123 and are adapted to fix the sample container 130. In the shown example, the fixing elements 105 are realized as sheet metal clamps which fix the lid 131 of the sample container 130 by a latching mechanism, as soon as they enclose it. For example, enclosing may be triggered by moving the sample handling device 100 in (vertical, z) direction of the sample container 130. However, if the fixing elements 105 can fix the sample container 130 or not depends here on the push-push mechanism 120 which can switch between a fixing mode and a release mode.

In the center of the housing 123, such a push-push mechanism 120 is provided. A push-push mechanism 120 as such is known (e.g. from a click-action pen), but not in connection with fixing/releasing a sample container 130 to/from a sample handling device 100 of an analysis device 10. In the example of FIG. 5, the push-push mechanism 120 comprises substantially two elements: a pushing element 125 and a spring element 121.

The pushing element 125 is elongated (i.e. comprises a main extension direction) and is partially arranged inside the housing 123. The pushing element 125 may consist of a multiplicity of materials, wherein plastic, metal, or ceramics may be preferred.

In the shown example, the spring element 121 is configured as a (elastic) spring which is attached on the one hand at the pushing element 125 and on the other hand inside the housing 123. Inside the housing 123, the spring 121 is in particular coupled with a component which comprises a so-called heart curve mechanics 122. By the heart curve shape component 122, it is enabled to change between a first position and a second position by a pressure impact (in particular “from above”) along the longitudinal extension of the spring 121. It is inherent for the push-push mechanism that a first pressure impact triggers the first position, a second pressure impact triggers the second position, and a third pressure impact in turn triggers the first position etc. In other words, each pushing action switches between both positions, which results also in the name push-push.

The pushing element 125 is coupled with the spring 121 and therefore co-performs its motion. Thus, when the spring 121 is tensioned, the pushing element 125 is pulled in the direction of the longitudinal extension of the spring 121 (and also along its own main extension direction) and is therefore pushed further into the housing 123. In turn, when the spring tension 121 is released, the pushing element 125 is pushed further out of the housing 123. In the present example, in the first position (not tensioned spring element), fixing the sample container 130 is made impossible and in the second position (tensioned spring element), fixing the sample container 130 is enabled.

In the present example, the pushing element 125, in the second position, is arranged further inside the housing 123 than in the first position. Thus, the first position corresponds to a state in which the pre-tension of the spring element 121 is lower than in the second position. As will be distinctly apparent from the FIGS. 5 and 6, the first position of the pushing element 125 corresponds to a state in which the fixing of the sample container 130 is made impossible, in other words to a release mode. On the contrary, the second position corresponds to a state in which the sample container 130 is fixable to the sample handling device 100, therefore to a fixing mode.

FIGS. 5a to 5d show the fixing of a sample container 130 at a sample handling device 100 according to an exemplary embodiment of the present disclosure.

FIG. 5a: the pushing element 125 of the push-push mechanism 120 of the sample handling device 100 is in the first position, i.e. the pushing element 125 is maximum pushed out of the housing 123 (low tension of the spring element 121). The pushing element 125 is centrally arranged between three fixing elements 105 (here sheet metal clamps with latching mechanism) and thereby make it impossible that the fixing elements 105 can fix and/or grip the lid 131 of the sample container 130.

FIG. 5b: the sample handling device 100 is lowered in the direction (of the gravity, along z) of the sample container 130 and placed on it by a sample moving device 150 which is not shown in this figure.

FIG. 5c: the sample handling device 100 is further lowered (by the sample moving device 150). By the sample container 130, a counter pressure is generated and, triggered by the pressure impact (from above and below), the pushing element 125 is displaced and/or pushed into the housing 123 and therefore changes from the first position in the second position. The pushing element 125 which is pushed away clears the path for an enclosing and/or gripping of the lid 131 of the sample container 130 by the fixing elements 105.

FIG. 5d: the second position of the pushing element 125 is now reached and the spring element 121 (not shown here) is pre-tensioned. Thereby, the fixing elements 105 can latch around the lid 131 and can securely hold the sample container 130 in the fixing mode. The sample moving device 150 can now flexibly transport the sample handling device 100 with the sample container 130 (in particular within the sampling space 180).

FIGS. 6a to 6d show the releasing of a sample container 130 from a sample handling device 100 according to an exemplary embodiment of the present disclosure.

FIG. 6a: starting in the fixing mode of FIG. 5d (pushing element 125 in the second position), the sample handling device 100 with the sample container 130 is transported to a desired location.

FIG. 6b: the sample moving device 150 lowers the sample handling device 100 and exerts a pressure, despite the sample container 130 is already placed on a ground. By the further pressure impact from the sample moving device 150 and the counter pressure of the placed sample container 130, the pushing element 125 is pushed further into the housing 123 and thereby triggers the push-push mechanism 120 again. This releases the tension of the spring element 121 and the pushing element 125 is pushed out of the housing 123 again. This happens at the same time with moving the sample moving device 150 (and therefore also the sample handling device 100) away from the sample container 130. Thereby, the pushing element 125 moves the lid 131 from between the fixing elements 105 and releases the latching mechanism.

FIG. 6c: the pushing element 125 has reached the first position again and occupies the space between the fixing elements 105. Thereby, fixing the sample container 130 is made impossible and releasing the sample container 130 occurs (release mode).

FIG. 6d: the sample handling device 100 is removed from the sample container 130 and remains at first in the first position in which no fixing is enabled.

FIG. 7 shows a sampling space 180 with a sample handling arrangement 160 according to an exemplary embodiment of the present disclosure. As already described above for FIG. 2, the sampling space 180 may comprise multiple sample container storing devices 137, between which the sample containers 130 are transported. The sample moving device 150 is configured as a robot arm and is moved by a drive 128. In the shown example, the sample moving device 150 is equipped with a needle arrangement (see FIGS. 1 and 8). This comprises an elongated sample needle 126, by which the fluidic sample can be sucked out of a sample container 130 and can then be transported to an injector of the analysis device 10. A further coupling region 112 which is configured as a plate is, in closest proximity, facing the sample containers 130. The further coupling region 112 comprises an opening through which the sample needle 126 can be guided.

If a sample container 130 shall now be transported (instead of removing fluidic sample), the sample handling device 100 can be coupled to the sample moving device 150, to obtain the sample handling arrangement 160. In the shown example, this may be accomplished specially efficiently, since the further coupling region 112 of the needle arrangement 190 can be attached to the coupling region 110 of the sample handling device 100 directly and without further modifications, e.g. by screwing-in. Thereby, depending on the need, the sample moving device 150 may be used for transporting the fluidic sample or the sample containers 130. Since the sample handling device 100 is passive and thus comprises neither a drive nor a drive coupling, the coupling with the sample moving device 150 may be performed especially simply and rapidly.

FIG. 8 shows a sampling space 180 with a sample moving device 150 (similar as in FIG. 7) in detail, according to an exemplary embodiment of the present disclosure.

According to FIG. 8, fluidic samples from a respective sample container receiving device 137 are handled which are here configured as microtiter plates. To receive a fluidic sample from a sample receiving indentation or from a sample container 130 in the sample container receiving device 137, the sample needle 126 is moved by the illustrated sample moving device 150 which is actively moved by the drive 128 to the fluidic sample to be received at a corresponding position of the sample container receiving device 137. As illustrated in FIG. 8, a needle housing 192 of the sample needle 126 which is rotationally mounted is received from a cantilever arm 178 of the sample moving device 150 and is moved to a target position. FIG. 8 also shows a fitting 199 at which a capillary (not shown in FIG. 8) as sample receiving volume 196 may be mounted in a high-pressure tight manner.

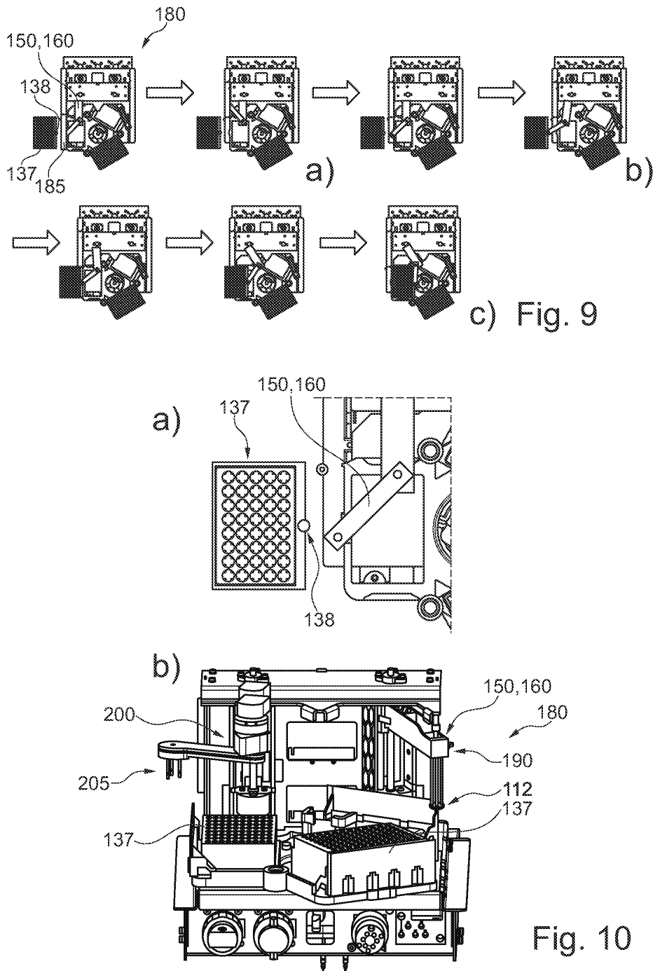

FIGS. 9a to 9c show the transport of a sample container receiving device 137 in a sampling space 180 by a sample moving device 150 according to an exemplary embodiment of the present disclosure. The sample moving device 150 may be a sample handling arrangement 160 which comprises the sample handling device 100.

In order to automatically, or in the course of a walk-up solution, deliver a sample container receiving device 137 and/or a sample plate to a sampling space 180 (sampler), automatic feeders are typically used. These solutions are active devices. For this purpose, a drive of an arbitrary configuration is required additionally to the sampler-robotics. Since the samplers 180 are mostly climatized, also the access into the interior must be closed by a driven door (opening mechanism) of an arbitrary configuration. Therefrom, a corresponding complexity of these units results.

However, according to an exemplary embodiment, the door 185 of the sampling space 180 is opened and closed by the robot and/or the sample moving device/-arrangement 150. This course of action may be characterized by no additional drives being necessary, instead the internal robotics is used.

FIG. 9a: the sample moving device 150 automatically opens the door 185 (here a sliding door) of the sampling space 180. No additional drive or robot is necessary, but only existing systems may be used.

FIG. 9b: the sample moving device 150 is coupled with the sample container receiving device 137. In order to draw the sample plate 137 into the device by means of the sampler-robotics 150, a corresponding coupling geometry 138 is provided at the pallet which carries the sample plate.

FIG. 9c: the sample moving device 150 draws and/or carries the coupled sample container receiving device 137 into the sampling space 180. In a not illustrated stage, the sample moving device 150 autonomously (automatically) closes the door 185.

FIGS. 10a and 10b show further views of the transport of a sample container receiving device 137 into the sampling space 180 by the sample moving device 150 according to an exemplary embodiment of the present disclosure. FIG. 10a is a detailed view which shows again the coupling geometry 138 of the pallet. FIG. 10b shows a sampling space 180 with two robot arms: a conventional gripper 200 (see FIGS. 2 and 3) and a sample moving device 150 which may be coupled with a sample handling device 100. Both robot arms may be used to open/close the door 138 and to transport sample containers (-receiving devices) into and/or out of the sampling space 180.

Thereby, it is not crucial if the robot has a gripping head. With corresponding adaptations also needles, pushers, or other front ends may be adapted. In this example, it is important that the internal robot is constructively implemented such that it can move out of the sampler.

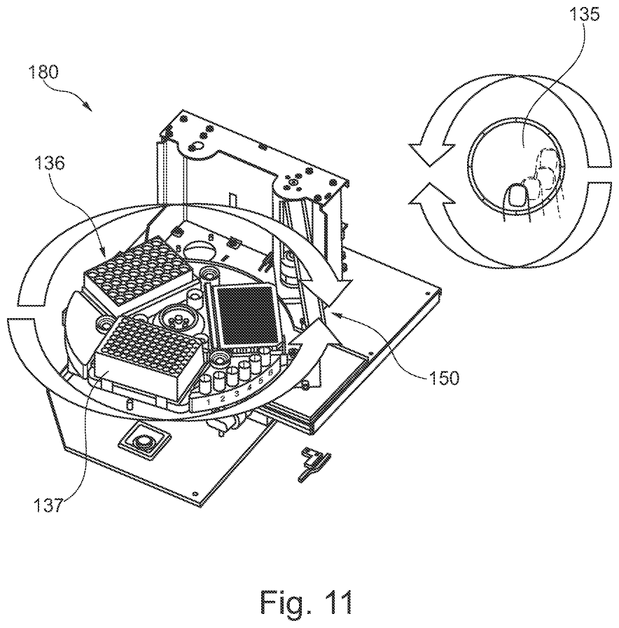

FIG. 11 shows a sampling space 180 with a sample moving device 150 and multiple sample container receiving devices 137 on a sample plate 136 according to an exemplary embodiment of the present disclosure. Conventionally, rotating sample plates are used which utilize one or more buttons which must be actuated multiple times or individually, to move the required sample plate to the discharge position. However, this may comprise disadvantages: i) when using one button, it must be pushed multiple times, until the desired sample plate can be removed, or ii) when using single buttons, the users must know on which place the required sample plate is located.

In the embodiment of FIG. 11, a so-called “jog dial” (operating element in devices, e.g. in form of a wheel which is rotatable by the finger, or scrolling wheel) as input device is used as an activator 135, in connection with a sampler which uses a rotating sample plate 136 for the storage. This results in an intuitive operation for loading and/or removing the samples. Each rotating motion at the jog dial 135 leads to a rotating motion of the sample plate 136. The operation of the sampler is thereby intuitive and less prone to errors.

In FIG. 11, the principal course of action is illustrated, wherein different technical implementations of a jog dial are possible. For example, rotating-latching-switches, special touch panels, touchless gesture systems, or an emulation via a touchscreen are possible. Also further functions may be established by corresponding gestures, courses of motions, or touch functions. Thus, for example a tapping on the jog dial could signalize a demand that the user desires an access, etc.

However, also further embodiments of an input device can be used. For example, these may encompass at least one switch which is configured for generating a control signal. For example, the input device may be configured to control the motion of the centrifugal robot assembly. In some embodiments, the input device may encompass a wired and/or wireless transmitter which is configured for transmitting a control signal to a wired and/or wireless receiver of a control. For example, an input device may contain a touch panel to enable that a user provides inputs (e.g. a finger contact to the touch panel) which correspond to a control signal. An input device inclusively a touch panel, may be configured to recognize a contact and a motion on the touch panel using a plurality of touch sensitivity technologies, inclusively capacitive, resistive, infrared-, optical imaging-, dispersive signal-, acoustic pulse recognition, and surface wave technologies.

In embodiments of an input device which encompass at least one switch, a switch may comprise for example at least one of the following: a button (e.g. a hard key, soft key), a touch panel, a keyboard, an analog stick (e.g. a joystick), a control crown, a pointing device (e.g. a mouse), a trackball, a jog dial, a step switch, a toggle switch, a pointer device (e.g. an input pen), a motion sensor, an image sensor, a microphone. A motion sensor may receive user motion data from an optical sensor and may classify a user gesture as a control signal. A microphone may receive audio and may recognize a user voice as a control signal.

However, the above-described input device (in particular the jog dial), besides the sample plate (rotary sample platter), may also be used for other (HPLC) applications, e.g. controlling a HPLC sampler or controlling a sample separation device.

It should be noted that the term “comprise” does not exclude other elements and that the term “a” does not exclude a plurality. Also elements which are described in connection with different embodiments may be combined. It should also be noted that reference signs in the claims are not to be construed as limiting the scope of protection of the claims.

### REFERENCE SIGNS

10 analysis device
20 fluid drive
25 supply unit
27 degasser
30 sample separation unit
40 injector
50 detector
60 fractionator
70 control unit
87 proportioning valve
90 injection valve
100 sample handling device
105 fixing element
110 coupling region
111 second fluid component source
112 further coupling region
113 first fluid component source
120 push-push mechanism
121 spring
122 heart curve mechanism
123 housing
124 fluidic separation path
125 pushing element
126 sample needle
128 drive
130 sample container, vial
131 sample container lid
134 needle seat
135 activator
136 sample plate
137 sample container receiving device
138 transport element, coupling geometry
150 sample moving device, robot arm
160 sample handling arrangement
171 first supply conduit
173 second supply conduit
178 cantilever arm
180 sampling space
185 door, opening mechanism
190 needle arrangement
192 needle housing
195 injector path
196 sample receiving volume
199 fitting

### PRIOR ART

200 gripper device
205 gripper head
220 motor

What is claimed is:

1. A sample handling device for handling a sample container, the sample handling device comprising:
a push-push mechanism configured to fix and release the sample container; and
a coupling region configured to couple to a sample moving device,
wherein the sample handling device is a passive device configured to perform fixing and releasing by the push-push mechanism free of a drive or a motor.

2. The sample handling device according to claim 1, further comprising a housing in which the push-push mechanism is at least partially arranged.

3. The sample handling device according to claim 1, wherein the push-push mechanism comprises a pushing element,
which, in a first position, makes the fixing of the sample container impossible; and
which, in a second position, enables the fixing of the sample container.

4. The sample handling device according to claim 3, wherein changing from the first position to the second position and vice versa is respectively enabled by a pressure impact on the sample handling device.

5. The sample handling device according to claim 3, wherein:
the pushing element is at least partially arranged in the housing; and
the pushing element, in the second position, is arranged further inside the housing than in the first position.

6. The sample handling device according to claim 3, comprising at least one of the following features:
wherein the pushing element is elongated;
wherein the pushing element is arranged such that a first pressure impact pushes the pushing element at least partially out of the housing, and a second pressure impact pushes the pushing element at least partially back into the housing;
wherein the pushing element is arranged such that the pushing direction is along a main extension direction of the pushing element;
wherein the pushing element is arranged such that the pressure impact is performed substantially in parallel to the gravity direction;
wherein the pushing element comprises at least one of the following materials: plastic; metal; ceramics.

7. The sample handling device according to claim 1, further comprising at least one fixing element configured to releasably fix the sample container or a sample container lid of the sample container,
wherein the push-push mechanism, in the first position, makes a fixing of the sample container by the fixing element impossible, and, in the second position, enables it.

8. The sample handling device according to claim 7, comprising at least one of the following features:
wherein the fixing element comprises at least one of the following: a folding element; a latching element; a clamp; a hose; a web; a magnet;
wherein the fixing element comprises at least one of the following materials: metal; plastic; ceramics.

9. The sample handling device according to claim 1, wherein the push-push mechanism comprises a spring element, and the tension of the spring element during fixing the sample container is higher than during releasing the sample container.

10. The sample handling device according to claim 9, wherein:
the spring element is configured as a spring which is changeable between a fixed position and a non-fixed position by a heart curve mechanism; and
the fixed position is associated with the second position of the pushing element, and the non-fixed position is associated with the first position of the pushing element.

11. The sample handling device according to claim 9, wherein the spring element comprises at least one of the following: an air cushion; an elastomer; an oil container; a gas pressure spring.

12. A sample handling arrangement, comprising:
the sample handling device according to claim 1; and
the sample moving device, which comprises a further coupling region for coupling the sample handling device,
wherein the sample handling device and the sample moving device are reversibly couplable with each other by the coupling and the further coupling.

13. The sample handling arrangement according to claim 12, wherein the sample moving device is an active device comprising a drive or a motor.

14. The sample handling arrangement according to claim 12, wherein the sample moving device is configured to exert a pressure on the sample handling device such that the push-push mechanism is thereby activated.

15. The sample handling arrangement according to claim 12, comprising at least one of the following features:
wherein the sample moving device comprises a cantilever arm;
wherein the sample moving device comprises a needle arrangement comprising a sample needle with a lumen for guiding a fluidic sample;
wherein the sample moving device comprises a sample needle that is movable through the further coupling.

16. An analysis device for analyzing a fluidic sample which is to be injected into a mobile phase, the analysis device comprising at least one sample handling device according to claim 1.

17. The analysis device according to claim 16, further comprising at least one of the following features:
the analysis device is configured as a sample separation device for separating the fluidic sample;
the analysis device comprises a fluid drive for driving a mobile phase and a fluidic sample which is injected in the mobile phase;
the analysis device comprises a fluid drive for driving a mobile phase and a fluidic sample which is injected in the mobile phase with a pressure of at least 500 bar;
the analysis device comprises a fluid drive for driving a mobile phase and a fluidic sample which is injected in the mobile phase with a pressure of at least 1000 bar;
the analysis device comprises a fluid drive for driving a mobile phase and a fluidic sample which is injected in the mobile phase with a pressure of at least 1200 bar;
the analysis device comprises a sample separation unit for separating the fluidic sample which is injected in the mobile phase;
the analysis device comprises a sample separation unit configured as a chromatographic separation unit;
the analysis device is configured for analyzing at least one physical, chemical, and/or biological parameter of the fluidic sample;
the analysis device is configured as a chromatography device;
the analysis device is configured as a microfluidic device;
the analysis device is configured as a nanofluidic device;
the analysis device comprises a detector for detecting the analyzed fluidic sample;
the analysis device comprises a fractionator for fractionizing separated fractions of the fluidic sample.

18. An analysis device for analyzing a fluidic sample which is to be injected into a mobile phase, the analysis device comprising at least one sample handling arrangement according to claim 12 for handling the fluidic sample.

19. A method for handling a sample container, the method comprising:
coupling a sample handling device to a sample moving device;
pressurizing the sample handling device by the sample moving device; and
triggering a push-push mechanism of the sample handling device for fixing and/or releasing the sample container.

20. The method according to claim 19, wherein the pressure acts through the sample moving device in a direction of the sample container.
